(19) United States
(12) Patent Application Publication
(10) Pub. No.: US 2019/0322157 A1
(43) Pub. Date: Oct. 24, 2019

(54) VEHICLE COMPRISING A SELECTIVELY OPENABLE AND CLOSABLE VENT DUCT AND METHOD OF USING THE SAME

(71) Applicant: Toyota Motor Engineering & Manufacturing North America, Inc., Plano, TX (US)

(72) Inventor: Ryan C. Harris, Saline, MI (US)

(21) Appl. No.: 15/961,162

(22) Filed: Apr. 24, 2018

(51) Int. Cl. B60H 1/26; B60J 1/17; B60J 1/18; B60J 7/043

(52) U.S. Cl. CPC B60H 1/267; B60J 1/17; B60J 7/043; B60J 1/1861; B60J 1/1876; B60J 1/1853

(57) ABSTRACT

A vehicle that comprises a passenger compartment comprising a plurality of door openings. The vehicle also includes a plurality of selectively openable and closable doors movably disposed in the door openings. The vehicle also includes a selectively openable and closable vent duct. The vehicle further includes a controller configured to selectively open and close the selectively openable and closable vent duct, the controller configured to control an open condition of the vent duct during a door close event or a door open event of one of the doors. The vehicle may use the controller to sense the door close event or the door open event for at least one of the doors and a vehicle state; determine whether an opening of a predetermined first cross-sectional area exists in that state; and if not, use the controller to control the open condition thereby providing the predetermined first cross-sectional area by opening the vent duct.

### FIELD OF THE INVENTION

The embodiments disclosed herein relate generally to a vehicle comprising a selectively openable and closable vent duct, and to a method of using a vehicle comprising a selectively openable and closable vent duct.

### BACKGROUND

Automotive vehicles, particularly various types of trucks, currently employ a vent duct, or a plurality of vent ducts, to facilitate closure of the vehicle doors. These door vent ducts provide an air conduit for the passage of air out of the passenger compartment during door closure to prevent the air that is already in the compartment together with the external air that is swept into the passenger compartment by closure of the doors from being compressed by the door closure so that the pressurized air acts to resist or prevent the closure of the door by providing a resistive force (increased air pressure) acting against the closure force. Such a resistive force can result in improper door closures, such as a door failing to completely close and latch (e.g. partial closure and/or non-closure), or require a force that is higher than a predetermined desired closure force needed to completely close the door (e.g. slamming the door). The movement of air through these air ducts equalizes the cabin pressure with the outside air pressure thereby avoiding cabin pressurization and improving the door closure performance by reducing the predetermined desired closure force. For example, the use of vent ducts reduces the predetermined closure force required to completely close the doors and/or reduces or eliminates the possibility or incidence of improper door closures.

Vent ducts are provided with a fixed size and shape sufficient to achieve a predetermined closure force. The vent duct or ducts are typically designed to provide a predetermined cross-sectional area. The predetermined cross-sectional area depends on various factors related to the vehicle dynamics associated with a door closure, including the volume of the passenger compartment, the size of the door opening, the door closure frictional resistance, the weight of the door, and other factors. Currently, vent ducts are fixed in size and location within the vehicle to provide a desired predetermined closure force for the particular vehicle and passenger compartment design of interest.

Current vehicular trends require the reduction of overall vehicle weight for improvement of vehicle performance, including, for example, fuel economy. Despite these changes, it is necessary to maintain or improve current vehicle performance, including door closure performance. Therefore, improved vehicle vent ducts and methods of making and using these vent ducts is very desirable.

### SUMMARY OF THE INVENTION

In one embodiment, a vehicle is disclosed. The vehicle comprises a passenger compartment comprising a plurality of door openings. The vehicle also includes a plurality of selectively openable and closable doors movably disposed in the door openings. The vehicle also includes a selectively openable and closable vent duct. The vehicle further includes a controller configured to selectively open and close the selectively openable and closable vent duct, the controller configured to control an open condition of the vent duct during a door close event or a door open event of one of the doors.

In another embodiment, a method of using a door closure vent duct in a vehicle is disclosed. The vehicle includes a passenger compartment comprising a plurality of door openings; a plurality of selectively openable and closable doors movably disposed in the door openings; a selectively openable and closable vent duct; and a controller configured to selectively open and close the selectively openable and closable vent duct, the controller configured to control an open condition of the vent duct during a door close event or an door open event of one of the doors. The method includes using the controller to sense the door close event and/or the door open event for at least one of the doors and a vehicle state. The method also includes determining whether an opening of a predetermined first cross-sectional area exists in the vehicle state. If no opening of the predetermined first cross-sectional area exists in the vehicle state, the method further includes using the controller to control the open condition thereby providing the predetermined first cross-sectional area by opening the selectively openable and closable vent duct.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of an exemplary embodiment of a vehicle comprising a selectively openable and closable vent duct with the vent duct in a closed condition;

FIG. 2 is a perspective view of the vehicle of FIG. 1 with the vent duct in an open condition;

FIG. 3 is a perspective view of a second exemplary embodiment of a vehicle comprising a selectively openable and closable vent duct with the vent duct in a closed condition;

FIG. 4 is a perspective view of the vehicle of FIG. 1 with the vent duct in an open condition;

FIG. 5 is a side view of a third exemplary embodiment of a vehicle comprising a selectively openable and closable vent duct with the vent duct in a closed condition (door windows) and open condition (pivotable rear window);

FIG. 6 is a top view of the vehicle of FIG. 5 with the vent duct in an open condition (door windows) and a closed condition (pivotable rear window);

FIG. 6A is a schematic cross-sectional view along Section A-A of FIG. 6; and

FIG. 7 comprises a flowchart of a method of using an embodiment vehicle comprising a selectively openable and closable vent duct.

### DESCRIPTION OF THE EMBODIMENTS

Automotive vehicles, particularly various types of trucks, currently employ a door vent duct (or ducts) having a fixed size and location in the vehicle, or a plurality of vent ducts, to facilitate closure of the vehicle doors. For example, in various types of trucks, including light-, medium-, and heavy-duty pickup trucks, vent ducts are generally located in the rear cabin panel that encloses the rear portion of the passenger compartment (e.g. the rearmost ceiling support pillars and/or wall). The rear cabin panel generally comprises a steel alloy. In the design of new vehicles, it desirable to reduce the vehicle weight by reducing the weight of many vehicle components and systems, including the vehicle doors. Door weight reduction may be accomplished through the use of lightweight aluminum alloy doors that are approximately fifty percent lighter than steel alloy doors of equivalent size. Reducing the weight of the vehicle doors requires a corresponding significant increase in the size, particularly the cross-sectional area, of the vent ducts to maintain the desired door open and close characteristics, such as the force required to open and close the doors. This is because the reduced door mass results in a lower kinetic energy of the door during application of a given open or close force, which in turn provides a reduced kinetic energy available to, respectively, expand or compress the volume of air in the passenger compartment. In order to maintain the same door open/close performance with lightweight or reduced weight doors, it is necessary to significantly increase the size of the vent ducts, particularly the cross-sectional area (e.g. for a 50% reduction in door weight, the cross-sectional area must increase by at least a factor of two). Significantly increasing the size of the vent ducts, particularly the cross-sectional area, is generally undesirable or not possible because this requires a concomitant reduction of the associated material that forms the rear cabin panel, which reduces the structural strength of the panel. In addition, in certain vehicle designs the presence of other components greatly limits or prevents the ability to increase the size of the vent ducts in their current preferred locations. For example, in trucks it is also frequently desirable to include a rear window in a portion of the rear cabin panel, particularly a movable rear window, which in turn requires a corresponding regulator mechanism(s), electric drive motor(s), and mounting hardware disposed on, within, or adjacent to the rear cabin panel. Applicant has discovered that the use of lightweight doors results in the need to find alternate vent ducts because the rear cabin panel in certain vehicle designs (e.g. smaller model sizes) no longer has sufficient area and/or volume available to provide the increased vent duct area and also meet other vehicle requirements, including rear panel strength requirements, particularly in cases where movable rear windows are employed.

Applicant has discovered that an automotive vehicle may be provided with new vent ducts using a synergistic combination and application of various vehicle components and systems and a new method of vehicle control. The new vent ducts may be used with conventional fixed position, fixed size vent ducts, or alternately, may be used to replace the conventional vent ducts, thereby providing a vehicle with no conventional fixed position, fixed size vent ducts mounted in the rear cabin panel. This invention is suitable for use in any automotive vehicle that includes a passenger compartment that requires a door vent duct for proper door closure, such as various trucks, including light-, medium-, and heavy-duty pickup trucks. The new vent duct, or vent ducts, are selectively openable and closable and utilize a vehicle controller that is configured to selectively open and close the selectively openable and closable vent duct(s), the controller configured to control an open condition of the vent duct and a predetermined first cross-sectional area of the duct during a door close event or a door open event of one of the doors. Upon completion of the door open or close event, the vent duct may be controlled to a predetermined second cross-sectional area that is less than the first area, and in many cases is zero, such that the vent duct is closed. The selectively openable and closable vent duct may include a selectively openable and closable electrically operable rear window of the vehicle, which is particularly applicable to various trucks, sport utility vehicles and minivans. The rear window may be movable in any suitable direction including vertically, horizontally, or may be outwardly/inwardly pivotable about a pivot (e.g. various forward side mounted or top mounted pivots) and comprise a pivotable window. Selectively openable and closable electrically operable door windows may also be used to provide the vent ducts. The vehicle heating, ventilating, air conditioning (HVAC) system includes a selectively openable and closable HVAC air conduit that may also be used to provide the vent duct. A selectively openable and closable electrically operable moonroof, sunroof, or panoramic roof may also be used to provide the vent duct. The selectively openable and closable vent ducts may be operated by a method comprising using the controller to sense the door close event and/or the door open event for at least one of the doors and a vehicle state. The method then includes determining whether an opening of a predetermined first cross-sectional area 51 exists in the vehicle state. If no opening of the predetermined first cross-sectional area 51 exists in the vehicle state, the method then also includes using the controller to control the open condition thereby providing the predetermined first cross-sectional area 51 by opening the selectively openable and closable vent duct. Upon completion of the door close event or open event, the method includes using the controller to control a closed condition/position 15 of the selectively openable and closable vent duct 12. This may include returning the vent duct to its initial condition/position 19 or any predetermined position. For example, if the vent duct was initially closed, it may be returned to a closed condition/position 15 as the initial condition/position 19. Alternately, if the vent duct was initially partially open, it may be returned to its initial partially opened condition/position as the initial condition/position 19.

As used herein, the terms front or forward or rear or rearward or aft refer to the front or rear of the article or vehicle, or to a direction toward the front or rear of the article or vehicle, respectively. The term longitudinal or along the length refers to a direction that extends along an article or vehicle centerline between the front and the rear. The term lateral or along the width or left-right refers to a direction that is orthogonal, or substantially orthogonal, to the longitudinal direction. The terms up or upward or down or downward refer to the top or bottom of the article or vehicle, or to a direction substantially toward the top or bottom of the article or vehicle, respectively. The terms in or inner or inward refer to a direction toward the center of the article or vehicle, and out or outer or outward refers to the opposite direction away from the center or central portion of the article or vehicle.

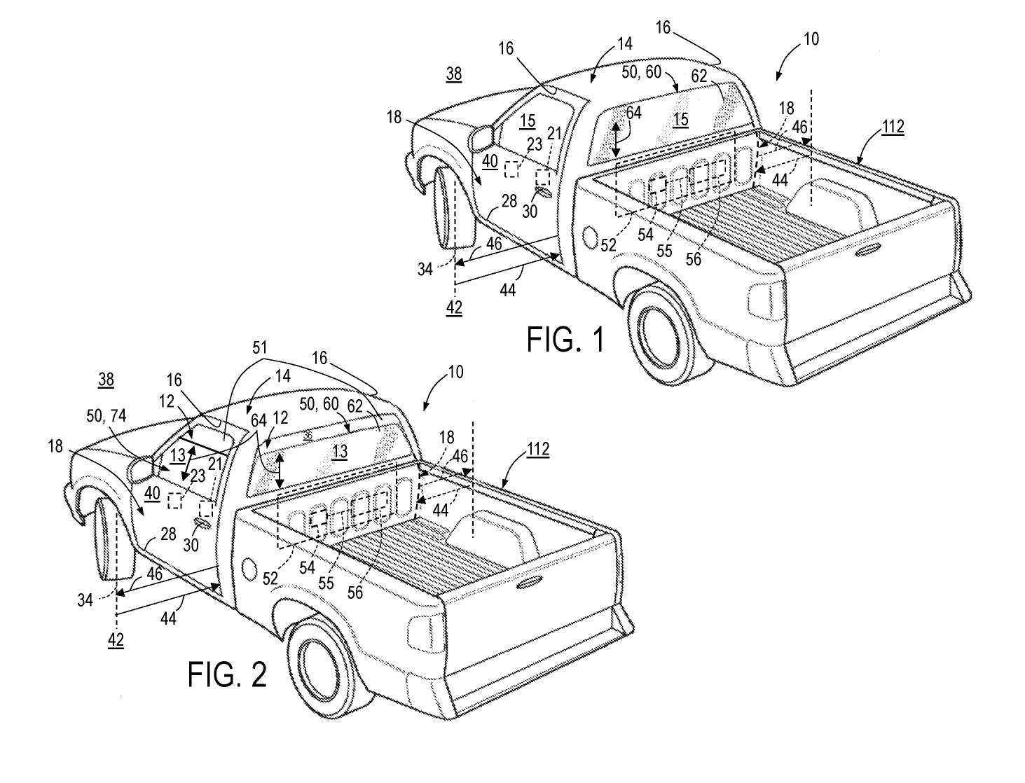

Referring to FIGS. 1-6A, several embodiments of a vehicle 10 comprising a selectively openable and closable vent duct 12 is disclosed. The vehicle 10 may comprise any suitable vehicle, particularly all manner of automotive vehicles, including all manner (e.g. makes, models, customizations, and duty ranges) of cars and light-duty, medium-duty, and heavy-duty trucks. In one embodiment, the vehicle 10 comprises a car, truck, minivan, or sport utility vehicle.

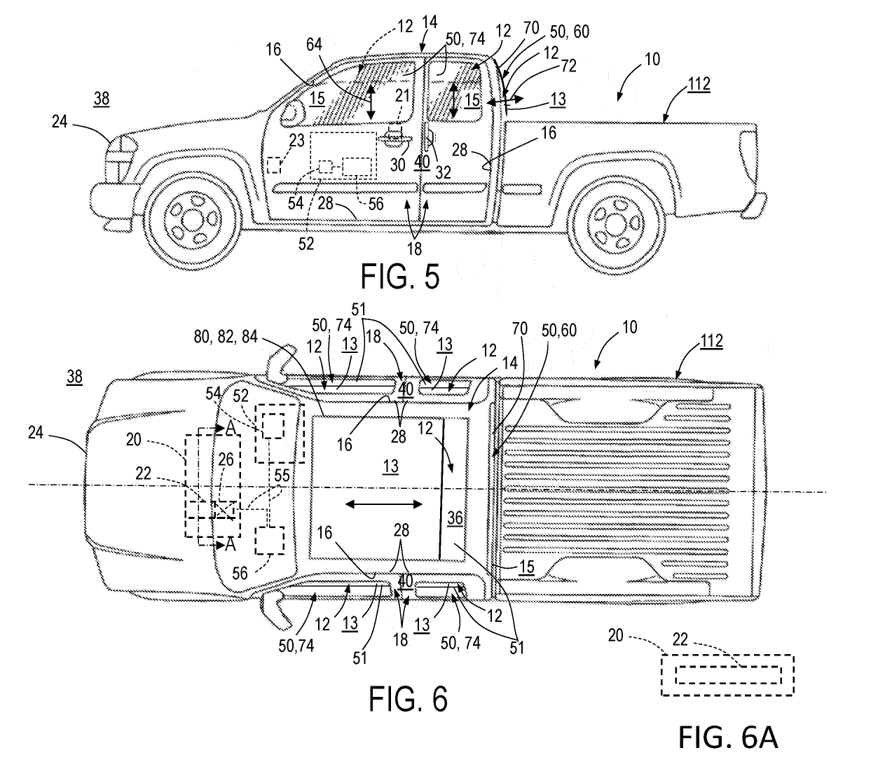

The vehicle 10 comprises a passenger compartment 14 comprising a plurality of door openings 16 and a corresponding plurality of selectively openable and closable doors 18 movably disposed in the door openings. The passenger compartment 14 is configured to receive various vehicle passengers, including a driver and generally one or more additional passengers. The passenger compartment 14 comprises vehicle seats (not shown) configured for passenger seating and various vehicle controls (not shown), including steering controls, such as a steering wheel, braking and engine controls, such as brake pedal operatively connected to the vehicle brakes and a gas pedal operatively connected to the engine and fuel systems, and environmental controls, such as heating, cooling and ventilation controls operatively connected to an HVAC system 20 as shown in phantom in FIG. 5. The HVAC system comprises a selectively openable and closable HVAC air duct 22 that is configured for selectively openable and closable fluid communication of air from the external environment through the engine compartment 24 to the interior of the passenger compartment using a selectively openable and closable electronic valve (or damper) 26 that is operably connected to and configured for signal communication with the controller 56. The selectively openable and closable HVAC air duct 22 is also configured for reverse operation and selectively openable and closable fluid communication of air within the interior of the passenger compartment to the external environment through the engine compartment 24 using the selectively openable and closable electronic valve (or damper) 26 as explained further herein.

The doors openings 16 may have any suitable size and shape and the corresponding selectively openable and closable doors 18 will have a size and shape configured to fit into and sealably cover and fill the openings. The selectively openable and closable doors 18 include a peripheral seal (not shown) proximate to and just inward of their peripheral edge 28 that seals the interior of the passenger compartment 14 from the external environment. The selectively openable and closable doors 18 may be movably disposed in the door openings 16 for any suitable opening and closing movement to seal the doors in the openings. In one embodiment as shown in FIGS. 1-4, the selectively openable and closable doors 18 are respectively pivotably outwardly movable (openable) toward a door open position 34 (FIGS. 1-4) and pivotably inwardly movable (closable) to the closed position shown in FIGS. 1-6. The selectively openable and closable doors 18 may be pivotably outwardly and inwardly, or alternately, upwardly and downwardly, movable by being hinged with one or more hinges (not shown) within the opening. In one embodiment, the selectively openable and closable doors 18 may be pivotably outwardly and inwardly movable by being hinged with one or more hinges (not shown) disposed between and attached to the door openings 16 and the doors 18 on the forwardmost vertical side of the opening opposite the side on which the first door latch handle 30 is disposed, as shown in FIGS. 1-5, for example. In another embodiment, the selectively openable and closable doors 18 may be pivotably outwardly and inwardly movable by being hinged with one or more hinges (not shown) disposed between and attached to the door openings 16 and the doors 18 on the rearwardmost vertical side of the opening opposite the side on which the second door latch handle 32 is disposed, as also shown in FIG. 5, for example. In still other embodiments, the doors may be pivotably upwardly (openable) and downwardly (closable) movable (not shown) by being hinged with hinges (not shown) disposed between and attached to the door openings 16 and the doors 18 on the uppermost horizontal side of the opening, such as gull wing doors or rear compartment or hatch doors. In yet other embodiments, the selectively openable and closable doors 18 may be pivotably outwardly and inwardly movable by being hinged with one or more sliding hinges. The may include sliding door/hinge and corresponding track arrangements as are used on minivans. The hinges used in these embodiments may comprise conventional vehicle door hinges of the types described.

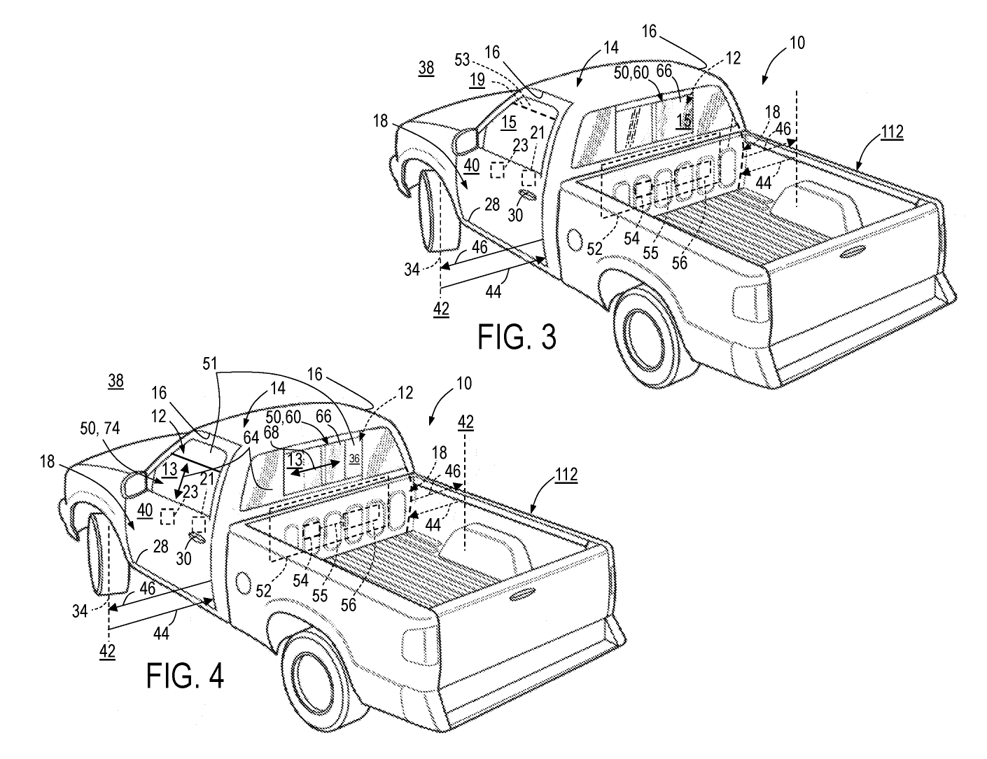

As described above, the vehicle 10 comprises a selectively openable and closable vent duct 12. The selectively openable and closable vent duct 12 may be any suitable selectively openable and closable air channel, passageway, opening, or conduit between the interior 36 and exterior 38 of the passenger compartment 14 that is configured for the communication of air therebetween. In one embodiment, the selectively openable and closable vent duct 12 may comprise a selectively openable and closable window 50 of the vehicle 10. The selectively openable and closable window 50 is operably connected to a selectively openable and closable window regulator mechanism 52 that may include various mechanical window frame, support, linkage, cable, and attachment members and an electric motor 54 that is operably connected to, in signal communication with, and configured for control by a controller 56 that is configured to selectively control the movement of the selectively openable and closable window 50 between a closed condition/position 15 and an open condition/position 13 to provide the selectively openable and closable vent duct 12. In one embodiment, the selectively openable and closable window 50 comprises a movable rear window 60. Movable rear window 60 may be used in any type of vehicle 10, but is particularly well-suited for use vehicles whose design frequently incorporates a movable rear window 60, including pickup trucks, SUV's, minivans, and station wagons. In one embodiment, movable rear window 60 comprises a vertically movable rear window 62 where the selectively openable and closable window regulator mechanism 52 and controller 56 are configured to slidably move the rear window glass up and down in a substantially vertical direction 64 (FIGS. 1 and 2). In another embodiment, movable rear window 60 comprises a horizontally movable rear window 66 where the window regulator mechanism 52 and controller 56 are configured to slidably move the rear window glass side to side in a substantially horizontal direction 68 (FIGS. 3 and 4). In yet another embodiment, movable rear window 60 comprises a pivotably movable rear window 70 where the selectively openable and closable window regulator mechanism 52 and controller 56 are configured to pivotably move the rear window glass by pivoting about a pivot, such as a window top or window side mounted pivot, in a substantially inward/outward direction 72 (FIGS. 5 and 6). In still another embodiment, the doors 18 comprise selectively openable and closable door windows 74 disposed therein where the selectively openable and closable window regulator 52 and controller 56 are configured to slidably move the door window glass up and down in a substantially vertical direction 64 (FIGS. 1-4 and 5). In this embodiment the selectively openable and closable window 50 comprises at least one of the selectively openable and closable door windows 74. The selectively openable and closable vent duct 12 may be provided using any one of the selectively openable and closable door windows 74, all of the door windows, or any combination of the door windows. For example, in one embodiment the selectively openable and closable door windows 74 on the side of the vehicle 10 opposite the selectively openable and closable door 18 being closed may be opened to reduce or hide the ability of a user to observe the movement of the windows. In another embodiment the selectively openable and closable door windows 74 on the same side of the vehicle as the selectively openable and closable door 18 being opened or closed may be opened, including the window of the door being opened/closed, to permit or enhance the ability of a user to observe the movement of the windows.

As shown in FIGS. 5-6A, in one embodiment the passenger compartment 14 comprises an HVAC system 20 that includes a selectively openable and closable HVAC air duct 22. The selectively openable and closable HVAC air duct 22 and selectively openable and closable electronic valve (or damper) 26 are operably connected to, in signal communication with, and configured for control by a controller 56 to provide the selectively openable and closable vent duct 12.

As also shown in FIGS. 5-6A, in one embodiment the passenger compartment 14 comprises at least one of a selectively openable and closable moonroof 80, sunroof 82, or panoramic roof 84. At least one of the moonroof 80, sunroof 82, or panorama roof (panoramic sunroof) 84 is configured for control by the controller 56 to provide the selectively openable and closable vent duct 12.

A vehicle 10 may include many combinations of selectively openable and closable windows 50, an HVAC system 20 that includes a selectively openable and closable HVAC air duct 22, and at least one of the moonroof 80, sunroof 82, or panorama roof 84. Any one, or any combination, of the selectively openable and closable windows 50, selectively openable and closable HVAC air duct 22 and HVAC system 20, and at least one of the moonroof 80, sunroof 82, or panorama roof 84 may be used to provide the selectively openable and closable vent duct 12.

From an open condition 42 of the selectively openable and closable door 18 at door open position 34, the selectively openable and closable vent duct 12 in an open condition/position 13 is configured for control to pass air into or out of the passenger compartment 14 during a door close event 44 and draw air into the passenger compartment during a door open event 46. In contrast, the selectively openable and closable vent duct 12 in a closed condition/position 15 is configured for control to not pass air into or out of the passenger compartment 14. A door close event 44 comprises application of an inward closing force to a selectively openable and closable door 18 in the door open position 34 and the subsequent acceleration and movement of the door until the door reaches the closed and latched position 40 (see FIGS. 1-6). A door open event comprises unlatching the selectively openable and closable door 18 in the closed and latched position 40 and application of an outward opening force to the selectively openable and closable door 18 and the subsequent acceleration and movement of the door until it reaches door open position 34 and an open condition 42 of the door as shown in FIGS. 1-4.

The selectively openable and closable vent duct 12 may have any suitable size and shape. In one embodiment, the size and shape is a predetermined size and shape selected as a function of a selectively openable and closable door 18 property, or a plurality of properties, to provide a predetermined door close or door open performance, which in one embodiment is a door closure performance that is not impeded by an increase of air pressure within the passenger compartment 14 over a predetermined range of door closure forces during corresponding door close events 44, and a door open performance that is not impeded by the air pressure within the passenger compartment over a predetermined range of door open forces during corresponding door open events 46.

In one embodiment, the selectively openable and closable vent duct 12 has a size and shape in an open condition 13 sufficient to vent a first predetermined volume of air from the passenger compartment 14 during a door close event and to admit a first predetermined volume of air into the passenger compartment 14 during a door open event. In one embodiment, the first predetermined volume of air is a volume of air necessary to avoid an increase in the pressurization of the passenger compartment air and a concomitant increase in air resistance to door closure and/or to maintain a predetermined door closure force or a predetermined range of door closure forces, which may differ as a function of the properties of the selectively openable and closable door 18 being closed and the corresponding passenger compartment 14 of the vehicle 10, including hinge friction, door weight, door size, door shape, door materials, passenger compartment volume and the like. In one embodiment, for the same selectively openable and closable door 18 size and/or shape in the same passenger compartment 14, the size and/or shape of the selectively openable and closable vent duct 12 varies as a function of the door material, including the density of the door material (e.g. steel alloys, aluminum alloys, various filled and unfilled polymers, or combinations or composites thereof), and in one embodiment the size increases inversely as a function of density (e.g. the size of the duct increases as the density of the door material decreases). In another embodiment, for the same selectively openable and closable door 18 size and/or shape in the same passenger compartment 14, the size and/or shape of the selectively openable and closable vent duct 12 varies as a function of the door weight, and in one embodiment the size of the duct increases inversely as a function of the door weight.

The size of the selectively openable and closable vent duct 12 may be characterized or measured in any suitable manner. In one embodiment, the selectively openable and closable vent duct 12 size is characterized by a predetermined first cross-sectional area 51 that comprises the portion of the duct that is open and through which air may flow (e.g. FIGS. 2 and 4) and may include the cross-sectional area of a plane generally orthogonal to the direction of air flow through the duct. In the case of selectively openable and closable windows 50, the predetermined first cross-section area 51 is the area of the window opening resulting from movement of the window glass and is bounded by the edge of the window glass proximate the opening and the exposed portion of the vehicle structure from which the window glass is withdrawn, and may comprise regular or irregular geometric shapes. In the case of selectively openable and closable windows 50, the shape of the window glass is fixed and as the window glass slides from a closed condition/position 15 where the cross-sectional area is zero to the open condition/position 13 where the predetermined first cross-sectional area 51 comprises the area of the resulting window opening. Therefore, the predetermined first cross-sectional area 51 varies as a function of the window position in the direction of movement and is at a maximum when the selectively openable and closable window regulator mechanism 52 is at its end of travel limits, which may include the entire window opening in embodiments where the window glass is fully retractable into the structure of the passenger compartment (e.g. a door in the case of door windows, the rear cabin panel in the case of vertically movable rear windows), or may be less than the entire window opening in embodiments where the selectively openable and closable window regulator mechanism 52 end of travel limit does not fully retract the window into the structure of the passenger compartment. For a given combination of selectively openable and closable movable windows, the window openings and the available predetermined first cross-sectional areas 51 of the windows can be mapped as a function of the window positions, and the map or maps can be stored in the memory of controller 56 and used a basis for controlling a predetermined cross-sectional area and position of a window or a plurality of windows during a door close event 44 or door open event 46. In the case of HVAC system 20 that includes a selectively openable and closable HVAC air duct 22 as the selectively openable and closable vent duct(s) 12, the predetermined first cross-sectional area 51 is the maximum cross-sectional area of the electronic valve (or damper) 26 in the fully open condition/position 13 of the selectively openable and closable electronic valve (or damper) 26. In the case of a variable selectively openable and closable valve (or damper) 26, the available predetermined first cross-sectional areas 51 can be mapped as a function of the electronic valve (or damper) position, and the map can be stored in the memory of the controller 56 and used a basis for controlling a predetermined cross-sectional area and position of the valve or damper during a door close event 44 or door open event 46. In one embodiment, the map(s) of the predetermined first cross-sectional areas 51 for the selectively openable and closable vent duct(s) 12 may be used to select a predetermined first cross-sectional area 51 or areas in an open condition 13 sufficient to vent a first predetermined volume of air from the passenger compartment 14 during a door close event 44 and to admit a first predetermined volume of air into the passenger compartment 14 during a door open event 46.

In one embodiment, the selectively the selectively openable and closable vent duct 12, or the plurality of selectively openable and closable vent ducts 12, is in a closed condition/position 15 as the initial condition/position 19 upon initiation of a door close event 44 or door open event 46, and following the event the duct(s) may be returned to the closed condition 15. In another embodiment, the selectively openable and closable vent duct 12, or the plurality of selectively openable and closable vent ducts 12, is in a partially open or fully open condition/position 13 as the initial condition/position 19 (FIG. 1) upon initiation of a door close event 44 or door open event 46 wherein the duct has a predetermined second cross-sectional area in the initial condition that is smaller than the predetermined first cross-sectional area 51, such that it is necessary to control the duct to the predetermined first cross-sectional area 51 during the event as described herein, and following the event the duct(s) may be returned to the initial condition 19 and a predetermined second cross-sectional area 53 (FIG. 3).

As described above, the vehicle 10 comprises a controller 56 configured to selectively open and close the selectively openable and closable vent duct 12. The controller 56 is configured to control an open condition 13 of the selectively openable and closable vent duct 12 during or in response to a door close event 44 or a door open event 46 of one of the doors 18 as described herein. Following a door close event 44 or a door open event 46 of one of the doors 18, the controller 56 is configured to control a closed condition 15 of the selectively openable and closable vent duct 12, or alternately, is configured to control an initial condition 19 of the selectively openable and closable vent duct 12, as described herein. The controller 56 is configured to selectively provide a control signal and/or power signal to the electric motor 54 and/or the electronic valve (or damper) 26, which in one embodiment is a selectively variable current signal that is applied through an electrical conductor, such as wire or cable 55 that is operatively connected to the electric motor 54 and/or the electronic valve (or damper) 26 and the controller 56, and is configured to provide a predetermined amount of current or a control signal sufficient to position the device (e.g. selectively openable and closable window 50, moonroof 80, sunroof 82, or panorama roof 84) operably connected to the electric motor 54 and/or the electronic valve (or damper) 26 to an open condition/position 13, including providing an opening with a predetermined first cross-sectional area 51. The controller 56 may include one or more controllers and may comprise a microcontroller(s) or microprocessor(s) or other controlling device, including an electronic control unit, such as one or more distributed vehicle control modules that are in signal communication with one another or networked via a wired communication bus, wireless communication bus, or a combination thereof. In an embodiment of controller 56 comprising an electronic control unit, such as one or more distributed vehicle control modules, the control modules may include a core comprising a microcontroller; volatile or nonvolatile memory including EERAM, ROM, and/or flash memory configured to store a table representative of a map of predetermined first cross-sectional areas 51 and/or predetermined second cross-sectional areas 53, for example; inputs including a supply voltage, digital inputs, and/or analog inputs representative of a user command or commands to map the predetermined first cross-sectional areas 51 and/or predetermined second predetermined cross-sectional areas 53 and make them user selectable; outputs, including relay drivers, bridge drivers, injector drivers, and/or logic outputs; communication links; output relays configured to control application of a current through the wire or cable 55 to the electric motor 54 and/or the electronic valve (or damper) 26.

In one embodiment, a vehicle 10 that includes a selectively openable and closable vent duct 12 as described herein may eliminate prior art fixed area, fixed position door vent ducts such that the vehicle has no fixed cross-sectional area door vent ducts. This is advantageous because it eliminates the cost of producing and installing these ducts. Elimination of the fixed area, fixed position door vent ducts is also advantageous because the members into which they were installed now are continuous and stronger because the vent duct openings have been eliminated and are also able to incorporate structural reinforcements, such as strengthening ribs. The vehicle 10 that includes selectively openable and closable vent duct 12 is also very advantageous because these vent ducts are provided by retasking and reprogramming existing elements of the vehicle (e.g. selectively openable and closable windows 50, electronic valve (or damper) 26 and/or moonroof 80, sunroof 82 or panorama roof 84) to eliminate current components while also strengthening the vehicle structure. The vehicle 10 that includes selectively openable and closable vent duct 12 is also very advantageous because it can accommodate lightweight selectively openable and closable doors 18, such as aluminum alloy doors, while maintaining or enhancing existing vehicle door open/close performance.

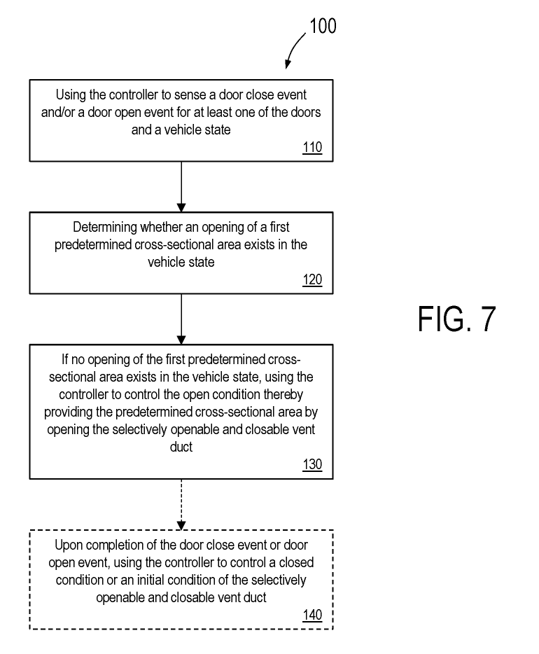

Referring to FIGS. 1-7, in one embodiment, a method 100 of providing a selectively openable and closable vent duct 12 in a vehicle 10 is disclosed. The vehicle 10, as described herein, comprises a passenger compartment 14 comprising a plurality of door openings 16; a plurality of selectively openable and closable doors 18 movably disposed in the door openings, a selectively openable and closable vent duct 12, and a controller 56 configured to selectively open and close the selectively openable and closable vent duct, the controller configured to control an open condition 13 of the vent duct during a door close event 44 or a door open event 46 of one of the doors. The method comprises: using 110 the controller to sense the door close event 44 and/or the door open event 46 for at least one of the doors and a vehicle state 112. The method 100 also includes determining 120 whether an opening of a predetermined first cross-sectional area 51 exists in the vehicle state. The method 100 also comprises and provides that if no opening of the predetermined first cross-sectional area 51 exists in the vehicle state, using 130 the controller 56 to control an open condition 13 of the selectively openable and closable vent duct 12 thereby providing the predetermined first cross-sectional area 51 by opening the selectively openable and closable vent duct 12. In one embodiment, the method 100 further comprises and provides that upon completion of the door close event 44 or door open event 46, using the controller 56 to control a closed condition 15 or an initial condition 19 of the selectively openable and closable vent duct 12. The method may be implemented as a stored program or code in the controller 56.

Using 110 the controller to sense the door close event 44 and/or the door open event 46 for at least one of the doors 18 and a vehicle state 112 may be accomplished by the controller 56 using any suitable combination of hardware and software. In one embodiment, the vehicle 10 doors 18 include motion sensors 23. The motion sensors 23 may include accelerometers that are operably connected to the controller 56 and are configured to sense an acceleration of the doors associated with a door close event 44 and/or the door open event 46 and provide an acceleration signal. Alternately, the controller 56 may be configured to sense or infer a door close event 44 and/or the door open event 46 based on a control signal to lock/unlock an electronic door lock 21. The vehicle state 112 may include assessment of the open conditions/positions 13 and/or closed conditions/positions 15 of any one of or all of the selectively openable and closable vent ducts 12, as well as computation of the open predetermined first cross-sectional area 51 of any one of them, or any combination of them, or all of them by, for example, comparing tables comprising the mapping of their respective conditions/positions, as described herein.

Determining 120 whether an opening of a predetermined first cross-sectional area 51 exists in the vehicle state 112 may be accomplished by the controller 56 using the assessment thereof made during using 110 as described above.

If no opening of the predetermined first cross-sectional area 51 exists in the vehicle state 112, it is necessary to implement using 130 the controller 56 to control an open condition 13 of the selectively openable and closable vent duct 12 thereby providing the predetermined first cross-sectional area 51 by opening the selectively openable and closable vent duct 12. Using 130 the controller 56 to control an open condition 13 of the selectively openable and closable vent duct or ducts 12 may be performed in the manner described herein using one or any combination of, including all of, the selectively openable and closable vent duct or ducts 12 available in the vehicle 10. For example, if some of the selectively openable and closable vent duct or ducts 12 are already in an open condition, but the sum of their open cross-sectional areas does not provide the predetermined first cross-sectional area 51, one or more of the selectively openable and closable vent duct or ducts 12, including the ones already open, may be controlled to an open condition/position 13 sufficient to provide the predetermined first cross-sectional area 51.

The terms “a” and “an” herein do not denote a limitation of quantity, but rather denote the presence of at least one of the referenced items. The modifier “about” used in connection with a quantity is inclusive of the stated value and has the meaning dictated by the context (e.g., includes the degree of error associated with measurement of the particular quantity). Furthermore, unless otherwise limited all ranges disclosed herein are inclusive and combinable (e.g., ranges of “up to about 25 weight percent (wt. %), more particularly about 5 wt. % to about 20 wt. % and even more particularly about 10 wt. % to about 15 wt. %” are inclusive of the endpoints and all intermediate values of the ranges, e.g., “about 5 wt. % to about 25 wt. %, about 5 wt. % to about 15 wt. %”, etc.). The use of “about” in conjunction with a listing of items is applied to all of the listed items, and in conjunction with a range to both endpoints of the range. Finally, unless defined otherwise, technical and scientific terms used herein have the same meaning as is commonly understood by one of skill in the art to which this invention belongs. The suffix “(s)” as used herein is intended to include both the singular and the plural of the term that it modifies, thereby including one or more of that term (e.g., the metal(s) includes one or more metals). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments.

It is to be understood that the use of “comprising” in conjunction with the components or elements described herein specifically discloses and includes the embodiments that “consist essentially of” the named components (i.e., contain the named components and no other components that significantly adversely affect the basic and novel features disclosed), and embodiments that “consist of” the named components (i.e., contain only the named components).

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A vehicle, comprising:
a passenger compartment comprising a plurality of door openings;
a plurality of selectively openable and closable doors movably disposed in the door openings;
a selectively openable and closable vent duct; and
a controller configured to selectively open and close the selectively openable and closable vent duct, the controller configured to control an open condition of the selectively openable and closable vent duct during a door close event or a door open event of one of the selectively openable and closable doors.

2. The vehicle of claim 1, wherein the selectively openable and closable vent duct has a predetermined first cross-sectional area in the open condition.

3. The vehicle of claim 2, wherein the selectively openable and closable vent duct has a predetermined second cross-sectional area in an initial condition that is smaller than the predetermined first cross-sectional area.

4. The vehicle of claim 1, wherein the selectively openable and closable vent duct comprises a selectively openable and closable air channel, passageway, opening, or conduit between an interior and an exterior of the passenger compartment.

5. The vehicle of claim 1, wherein the passenger compartment comprises a selectively openable and closable window that is configured for control by the controller to provide the selectively openable and closable vent duct.

6. The vehicle of claim 5, wherein the selectively openable and closable window comprises a vertically movable rear window.

7. The vehicle of claim 5, wherein the selectively openable and closable window comprises a horizontally movable rear window or a pivotable window.

8. The vehicle of claim 1, wherein the selectively openable and closable doors comprise selectively openable and closable door windows disposed therein, and wherein the selectively openable and closable window comprises at least one of the selectively openable and closable door windows.

9. The vehicle of claim 1, wherein the passenger compartment comprises an HVAC system that includes a selectively openable and closable HVAC air conduit, and wherein the selectively openable and closable air conduit is configured for control by the controller to provide the selectively openable and closable vent duct.

10. The vehicle of claim 1, wherein the passenger compartment comprises at least one of a selectively openable and closable moonroof, sunroof, or panoramic roof, and wherein at least one of the selectively openable and closable moonroof, sunroof, or panoramic roof is configured for control by the controller to provide the selectively openable and closable vent duct.

11. The vehicle of claim 1, wherein the vehicle has no fixed cross-sectional area door vent ducts.

12. The vehicle of claim 1, wherein the vehicle is a car, truck, minivan, or sport utility vehicle.

13. A method of using a selectively openable and closable vent duct in a vehicle comprising: a passenger compartment comprising a plurality of door openings, a plurality of selectively openable and closable doors movably disposed in the door openings, the selectively openable and closable vent duct, and a controller configured to selectively open and close the selectively openable and closable vent duct, the controller configured to control an open condition of the selectively openable and closable vent duct during a door close event or a door open event of one of the selectively openable and closable doors; comprises:
using the controller to sense the door close event and/or the door open event for at least one of the doors and a vehicle state;
determining whether an opening of a predetermined first cross-sectional area exists in the vehicle state; and
if no opening of the predetermined first cross-sectional area exists in the vehicle state, using the controller to control the open condition thereby providing the predetermined first cross-sectional area by opening the selectively openable and closable vent duct.

14. The method of claim 13, further comprising:
upon completion of the door close event or door open event, using the controller to control a closed condition or an initial condition of the selectively openable and closable vent duct.

15. The method of claim 13, wherein the passenger compartment comprises a selectively openable and closable window that is configured for control by the controller to provide the selectively openable and closable vent duct.

16. The method of claim 15, wherein the selectively openable and closable window comprises a vertically movable rear window, a horizontally movable rear window, or a pivotable window.

17. The method of claim 13, wherein the selectively openable and closable doors comprise selectively openable and closable door windows disposed therein, and wherein the selectively openable and closable window comprises at least one of the selectively openable and closable door windows.

18. The method of claim 13, wherein the passenger compartment comprises an HVAC system that includes a selectively openable and closable HVAC air conduit, and wherein the selectively openable and closable air conduit is configured for control by the controller to provide the selectively openable and closable vent duct.

19. The method of claim 13, wherein the passenger compartment comprises at least one of a selectively openable and closable moonroof, sunroof, or panoramic roof, and wherein at least one of the selectively openable and closable moonroof, sunroof, or panoramic roof is configured for control by the controller to provide the selectively openable and closable vent duct.

20. The method of claim 14, wherein the vehicle state comprises the open or closed condition of: the other selectively openable and closable doors, each of a plurality of selectively openable and closable windows, and a selectively openable and closable HVAC air conduit.
